(19) United States
(12) Patent Application Publication
(10) Pub. No.: US 2010/0100749 A1
(43) Pub. Date: Apr. 22, 2010

(54) Single-Chip Computer and Tachograph

(75) Inventors: Rudolf Gerber, Konigsfeld (DE); Charles Hardinge, Villingen-Schwenningen (DE); Roland Lange, Brigachtal (DE); Andreas Lindinger, Flozlingen (DE); Gerhard Rombach, Triberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GMBH, Hannover (DE)

(21) Appl. No.: 12/524,295

(22) PCT Filed: Jan. 10, 2008
(86) PCT No.: PCT/EP2008/050218

§ 371 Date: Jul. 23, 2009

(30) Foreign Application Priority Data
Jan. 23, 2007 (DE) 10 2007 004 280.0

(51) Int. Cl. G06F 12/14; G06F 21/02; G06F 17/00

(52) U.S. Cl. 713/193; 713/194; 701/35

(57) ABSTRACT

A single-chip computer includes at least one first processor core and at least one second processor core constructed on a common chip. The at least one first and the at least one second processor cores are interconnected via a processor interface. Data can be read via a separate or common memory interface from a separate or common data memory respectively and/or stored in said data memory. The single-chip computer includes an encryption and decryption unit which is assigned to the at least one processor core and which is constructed and functionally arranged between the at least one second processor core and the memory interface in such a way that the data which can be exchanged between the at least one second processor core and the data memory can be encrypted and decrypted by the encryption and decryption unit.

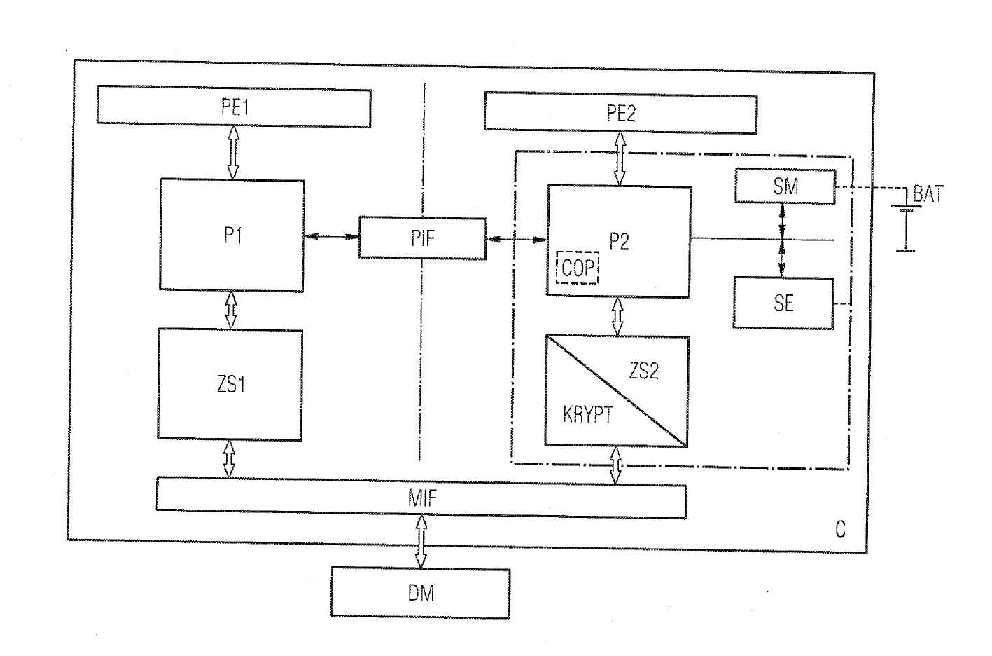

### PRIORITY CLAIM

This is a U.S. national stage of application No. PCT/EP2008/050218, filed on 10 Jan. 2008, which claims Priority to the German Application No.: 10 2007 004 280.0, filed: 23 Jan. 2007, the contents of both being incorporated herein by reference.

### BACKGROUND OF THE INVENTION

1. Field of the Invention

The invention relates to a single-chip computer, particularly for use in a vehicle. The invention also relates to a tachograph, particularly a digital tachograph.

2. Prior Art

DE 10 2004 028 338 A1 discloses a tachograph that stores vehicle operating data digitally in a memory. The tachograph has a first microcontroller with a processor core coupled to a memory arranged externally with respect to the first microcontroller via a buffer store and an encryption unit arranged in the first microcontroller. The microcontroller also has an internal memory and a safety sensor system as integral components. The safety sensor system monitors at least one safety-critical environmental parameter. The first microcontroller is connected to a second microcontroller. The second microcontroller is connected to a user system or a display system and controls the display system or the operation of the user elements.

DE 100 14 994 A1 discloses a memory having a memory interface associated with a data bus in a vehicle. The memory interface supplies the memory with data interchanged between components of the vehicle via the data bus. The data stored in the memory is used for data interpretation to reconstruct vehicle use and wear.

WO 2004/068344 A1 discloses a computer system in a vehicle having at least two computers. The first computer has associated travel and/or vehicle related tasks and functions, and the second computer essentially has no associated travel and/or vehicle related tasks and functions. By way of example, the second computer is associated with an entertainment system in the vehicle.

### SUMMARY OF THE INVENTION

An object of the invention is to provide a secure and powerful single-chip computer and tachograph.

In line with a first embodiment of the invention, a single-chip computer comprises at least one first processor core and at least one second processor core produced on a shared chip. The at least one first processor core and the at least one second processor core are coupled to one another via a processor interface for transferring data from the at least one first processor core to the at least one second processor core and/or for transferring data from the at least one second processor core to the at least one first processor core. The single-chip computer comprises a respective or shared memory interface for the at least one first processor core and the at least one second processor core. Data is read from and/or stored in a respective or shared data memory via the respective or shared memory interface. The single-chip computer also comprises an encryption and decryption unit associated with the at least one second processor core and designed so that its functions are arranged between the at least one second processor core and the memory interface such that the data interchanged between the at least one second processor core and the data memory is encrypted and decrypted by the encryption and decryption unit.

The at least one second processor core is provided for execution of at least one cryptographic or other security-related program. For this purpose, the at least one second processor core has at least one associated coprocessor for the purpose of cryptographically processing data, or the at least one second processor core comprises at least one such coprocessor. In addition, the at least one second processor core has associated secure memory, particularly a secure key memory for storing at least one cryptographic key.

The at least one first processor core is provided for execution of at least one non-security-related program, for example for control of functions of a tachograph. However, from this at least one non-security-related program, the processor interface can very easily and quickly access services or functions provided by the at least one security-related program running on the at least one second processor core.

One advantage is that by providing a physical and logical separation between the at least one first and the at least one second processor core on the chip, these processor cores are operated independently of one another. In particular, the at least one first and the at least one second processor core can execute different operating systems and/or programs subject to different security requirements. This separation allows a high level of security. In addition, security certification is significantly simplified, since only those portions of the single-chip computer and/or of the programs which are subject to the high level of security requirements need to be certified, that is to say particularly preferably the at least one second processor core with the components of the single-chip computer associated therewith and/or the operating system and/or the at least one program which is intended to be executed on the at least one second processor core.

A further advantage is that by producing the at least one first and the at least one second processor core on the shared chip, the single-chip computer is a particularly compact and inexpensive design. In addition, the data interchange between the at least one first and the at least one second processor core can take place very quickly via the processor interface. As a result, the single-chip computer can be very powerful. In addition, providing the internal processor interface saves external connections.

External connections are also saved by providing the shared memory interface. This allows a single-chip computer which is of very compact design and which can be used easily and inexpensively in a circuit arrangement. In addition, by providing the shared memory interface and the shared data memory, it is simple for a memory content of the shared data memory to have its integrity checked, by the at least one second processor core. By providing the respective memory interface and the respective memory, it is possible to achieve a particularly high data transfer capacity between the at least one first processor core and the data memory associated therewith and between the at least one second processor core and the data memory associated therewith. The processor cores are preferably proportioned with the respective requirements. The parallel and mutually independent program execution means that the single-chip computer can be particularly powerful.

In one advantageous embodiment, the single-chip computer comprises at least one first peripheral unit associated with the at least one first processor core, and at least one second peripheral unit associated with the at least one second processor core. The at least one first and the at least one second peripheral unit are in the form of an interface to an external unit or in the form of an internal functional unit or in the form of a further memory of the single-chip computer. The at least one first and the at least one second peripheral unit comprise at least use of a digital an analog input, an analog output, an analog/digital converter, a digital/analog converter, a serial and/or parallel digital interface, a chip card interface, register, a realtime clock, a counter device, a time control device, and a unit for producing or capturing pulse-width-modulated signals. The advantage is that by providing the at least one first and the at least one second peripheral unit, a high level of integration is possible and as a result no corresponding external assemblies are required. In addition, the fact that the at least one second processor core has the at least one second peripheral unit associated with it means that a high level of security is possible.

In a further advantageous embodiment, the single-chip computer comprises at least one protective device designed to monitor at least one operating parameter of the single-chip computer and/or a mechanical integrity of the single-chip computer. The single-chip computer is designed to prevent operation of the at least one second processor core when the at least one protective device has recognized a discrepancy between the at least one operating parameter and a prescribed value range of the at least one operating parameter or has recognized an infringement of the mechanical integrity of the single-chip computer. In addition, the single-chip computer is designed to at least partially maintain operation of the at least one first processor core when the operation of the at least one second processor core is prevented. This has the advantage that it allows a high level of security against manipulation of the single-chip computer. In addition, a high level of availability of the at least one first processor core is possible, which means that non-security-related applications can be operated at least in an emergency mode.

In line with a second embodiment of the invention, a tachograph comprises at least one of the single-chip computers. The advantage is that such a tachograph may be secure, particularly powerful and particularly inexpensive.

### BRIEF DESCRIPTION OF THE DRAWINGS

Exemplary embodiments of the invention are explained below with reference to the schematic drawing.

The single FIGURE is a block diagram of a tachograph with a single chip computer.

### DETAILED DESCRIPTION OF THE DRAWINGS

The single-chip computer, which is represented by its chip C, a data memory DM and a power source, which is represented by a battery BAT, comprises at least one first processor core P1 and at least one second processor core P2, which are coupled to one another via a processor interface PIF. It is also possible in one embodiment for the data memory DM to be produced on the chip C. The at least one second processor core P2 preferably has at least one associated coprocessor COP designed for cryptographically processing data supplied to the at least one second processor core P2 via the processor interface PIF from the at least one first processor core P1. By way of example, cryptographic processing comprises encryption or decryption of data, by DES, 3DES or RSA algorithm or by another algorithm, production or checking of a digital signature and/or the performance of authentication. The at least one second processor core P2 preferably comprises the at least one coprocessor COP.

The processor interface PIF is in the form of an internal, serial or parallel, digital interface integrated on the chip C and has its functions arranged between the at least one first and the at least one second processor core P1, P2. However, the processor interface PIF may also be in the form of a jointly useable buffer store, which is typically referred to as a shared memory or as a dual-port RAM.

The at least one first processor core P1 preferably has associated with it at least one first peripheral unit PE1 and/or a first buffer store ZS1, which can also be referred to as a cache memory. The at least one second processor core P2 preferably has associated with it at least one second peripheral unit PE2 and/or at least one second buffer store ZS2, which can also be referred to as a cache memory. The at least one second processor core P2 also has an encryption and decryption unit KRYPT, and a secure memory SM and/or a protective device SE, associated with it. The at least one first and the at least one second peripheral unit PE1, PE2 are in the form, of an interface to an external unit, which is not produced on the chip C, or in the form of an internal functional unit or in the form of a further memory of the single-chip computer. The at least one first and the at least one second peripheral unit PE1, PE2 comprise a digital and/or an analog input and/or output and/or an analog/digital converter and/or a digital/analog converter and/or a serial and/or parallel digital interface and/or a chip card interface and/or register and/or a real time clock and/or a counter device and/or a time control device and/or a unit for producing or capturing pulse-width-modulated signals, for example. The at least one first and the at least one second peripheral unit PE1, PE2 may also be in a different form.

The single-chip computer comprises a memory interface MIF. The memory interface MIF preferably comprises a memory management unit designed to control memory access operations. The memory interface MIF is coupled to the external data memory DM. In one embodiment, the memory interface MIF is coupled to the at least one first processor core P1 via the first buffer memory ZS1. In addition, the memory interface MIF is coupled to the at least one second processor core P2 via the encryption and decryption unit KRYPT and the buffer store ZS2. The at least one first processor core P1 and the at least one second processor core P2 preferably use the shared memory interface MIF to respectively effect read and/or write access to the shared data memory DM. By providing the shared memory interface MIF, it is possible for the single-chip computer to be produced on a small chip area and with a small number of external connections for coupling to the data memory DM.

In one embodiment, the at least one first processor core P1 and the at least one second processor core P2 are allocated a respective memory interface and a respective data memory separately from one another. This allows particularly fast access by the respective processor core its respective data memory.

Preferably, at least one program is stored on the data memory DM. Preferably, at least one program is stored on the data memory DM for the at least one first processor core P1 and for the at least one second processor core P2, respectively. The respective at least one program preferably comprises an operating system. Preferably, the at least one program of the at least one second processor core P2 is stored on the data memory DM in encrypted form. When the at least one program is read by the at least one second processor core, said program is decrypted by the encryption and decryption unit KRYPT. However, the at least one program may also be stored in a preferably non-volatile memory which is produced in the chip C, the at least one program then does not need to be stored in encrypted form.

However, the data memory DM can also be used to store other data, for example traveling data for a vehicle, for example a speed of travel and a traveling time for the vehicle. These data are preferably encrypted by the at least one second processor core P2 or the encryption and decryption unit and, having been provided with checking data, stored in the data memory DM. By way of example, the checking data is in the form of cyclic redundancy checking data which can be checked by means of a cyclic redundancy check, which may also be called CRC for short, or in the form of a digital signature. The checking data may also be in a different form.

The secure memory SM, which is associated with the at least one second processor core P2, is used to store at least one cryptographic key. The at least one cryptographic key is used by the at least one processor core P2 or its at least one coprocessor COP and/or by the encryption and decryption unit KRYPT for cryptographically processing data. The data is supplied to the at least one processor core P2 or the encryption and decryption unit KRYPT via the at least one processor interface PIF or via the memory interface MIF. In addition, provision may be made for data to be processed cryptographically which is supplied to the at least one second processor core P2 from the at least one second peripheral unit PE2. In addition, the at least one program which is intended to be executed on the at least one second processor core P2 may also be stored in the secure memory SM.

The secure memory SM may be in volatile or non-volatile form If the secure memory SM is in volatile form, the battery BAT is provided to prevent an undesirable loss of memory content, that is to say of the at least one cryptographic key and possibly of the at least one program. The advantage is that the memory unit can be very easily erased from the secure memory SM in volatile form to ensure the confidentiality of the memory content. If the secure memory SM is in non-volatile form, the battery BAT is not required. One advantage is that the memory content of the secure memory SM in non-volatile form is permanently and reliably protected against loss. However, it may be necessary to take measures which ensure the confidentiality of the memory content.

The at least one protective device SE provided for monitoring at least one operating parameter of the single-chip computer and/or a mechanical integrity of the single-chip computer. By way of example, the at least one operating parameter comprises one or more of an operating voltage, an operating temperature, and a clock frequency of the single-chip computer. Preferably, the at least one protective device SE is designed to check whether the at least one operating parameter is below a prescribed lower threshold value or above a prescribed upper threshold value, that is to say leaves a value range of the at least one operating parameter which is prescribed by the lower and the upper threshold value.

For high security requirements, the at least one protective device SE preferably comprises a protective grating or the like such as an upper most metallization plane on the chip C and which preferably covers at least the secure memory SM, the at least one second processor core P2, the encryption and decryption device KRYPT and the possibly provided second buffer store ZS2. This is indicated in the FIGURE by a dashed frame around these components of the single-chip computer. However, the protective grating can also cover the entire chip C. The at least one protective device SE is designed to recognize damage to the protective grating. This makes it possible to recognize any infringement of the mechanical integrity of the single-chip computer. The at least one protective device SE may also be in a different form.

The single-chip computer is preferably designed to take a result from the check on the at least one operating parameter or the mechanical integrity of the single-chip computer as a basis for performing protection measures for protecting the confidentiality of the memory content of the secure memory SM and/or of the data memory DM. These protection measures may comprise the erasure of the memory content of the secure memory SM, if said memory is in volatile form, and possibly of the data memory DM. In addition, provision may be made for operation of the at least one second processor core P2 to be prevented following the erasure. However, the operation of the at least one first processor core P1 is preferably at least partially maintained, for example in the form of an emergency mode. In the emergency mode, the functionality of the single-chip computer is no longer completely available. In one embodiment, the at least one second processor core P2 is no longer available for the cryptographic processing of data. Program portions of the at least one program which runs on the at least one first processor core P1 which are not reliant on the operation of the at least one second processor core P2 can continue to be used. This allows a high level of availability for the single-chip computer, for example without endangering the confidentiality or integrity of the data stored in the data memory DM in encrypted form. By way of example, a signal from the realtime clock can continue to be recognized, the analog/digital converter can continue to be operated and data can continue to be output on the digital interface, for example a CAN bus. This may allow system failure within the vehicle to be prevented.

The provision of the at least one first and the at least one second processor core P1, P2 has the advantage that the single-chip computer is designed for the respective provided application on the basis of the respective security requirements and the respective capacity requirements. By way of example, the processor cores can be dimensioned to have computation capacities which are independent of one another. In addition, the programs can be executed independently of one another and in parallel with one another on the at least on first and the at least one second processor core P1, P2. This means that the single-chip computer is particularly powerful.

If security certification is required for the operation of the single-chip computer, as in the case of use in the tachograph, a further advantage is that said security certification generally relates only to the at least one program which is to be executed on the at least one second processor core P2 and possibly on the at least one coprocessor COP thereof. This allows significant costs to be saved which would otherwise arise as a result of the security certification. In addition, only the at least one program which is to be executed on the at least one second processor core P2 needs to be stored in encrypted form and decrypted for the execution. The at least one program which is to be executed on the at least one first processor core P1 does not need to be stored in encrypted form and therefore also does not need to be decrypted for the execution. This allows computation capacity to be saved, which means that the single-chip computer is particularly powerful. In addition, the security requirements can thus be implemented easily and inexpensively, for example on the basis of the criteria for assessing the security of information technology, ITSEC for short.

In addition, the single-chip computer may be of particularly compact and inexpensive design, for example by providing the common memory interface MIF and/or through joint use of resources of the single-chip computer, for example a power supply, of signals or of interrupts.

The single-chip computer can also be used in other apparatuses and for other applications.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. A single-chip computer comprising:
at least one first processor core produced on a shared chip;
at least one second processor core produced on the shared chip;
a processor interface configured to couple the at least one first processor core and the at least one second processor core for transferring data between the at least one first processor core and the at least one second processor core;
at least one of a respective memory interface for each of the at least one first processor core and the at least one second processor core and a shared memory interface for the at least one first processor core and the at least one second processor core, the one of a respective memory interface and shared memory interface configured for interfacing the at least one first processor core and the at least one second processor core with one or more memories; and
an encryption and decryption unit arranged between the at least one second processor core and the memory interface configured for encrypted and decrypted interchange of data between the at least one second processor core and the one or more memories.

6. The single-chip computer according to claim 5, further comprising:
at least one first peripheral unit associated with the at least one first processor core; and
at least one second peripheral unit associated with the at least one second processor core.

7. The single-chip computer according to claim 5, further comprising:
at least one protective device configured to monitor at least one of an operating parameter of the single-chip computer and a mechanical integrity of the single-chip computer, the at least one protective device further configured to prevent operation of the at least one second processor core when the at least one protective device recognizes a discrepancy between the at least one operating parameter and a prescribed value range of the at least one operating parameter or wherein the at least one protective device has recognizes an infringement of the mechanical integrity of the single-chip computer,
wherein the at least one protective device at least partially maintains operation of the at least one first processor core when the operation of the at least one second processor core is prevented.

8. The single-chip computer according to claim 5, wherein the single-chip computer is integrated into a tachograph.

9. The single-chip computer according to claim 5, wherein the protective device comprises a protective grating that covers the at least one second processor core.

10. The single-chip computer according to claim 9, wherein the protective grating is a metallization layer configured to cover the an encryption and decryption unit.

11. The single-chip computer according to claim 6, wherein the at least one first peripheral unit is at least one of a digital input, an analog input, an analog output, a digital output, an analog converter, a digital converter, a digital-to-analog converter, an analog-to-digital converter, a serial digital interface, a parallel digital interface, a chip card interface, a register, a realtime clock, a counter, a time control unit, a unit for producing pulse-width-modulated signals, and a unit for capturing pulse-width-modulated signals.

12. The single-chip computer according to claim 6, wherein the at least one second peripheral unit is at least one of a digital input, an analog input, an analog output, a digital output, an analog converter, a digital converter, a digital-to-analog converter, an analog-to-digital converter, a serial digital interface, a parallel digital interface, a chip card interface, a register, a realtime clock, a counter, a time control unit, a unit for producing pulse-width-modulated signals, and a unit for capturing pulse-width-modulated signals.

13. The single-chip computer according to claim 8, wherein the tachograph is configured to store traveling data for a vehicle.

14. The single-chip computer according to claim 13, wherein the traveling data is at least one of travel time and travel speed.
